(19) United States
(12) Patent Application Publication
(10) Pub. No.: US 2005/0147638 A1
(43) Pub. Date: Jul. 7, 2005

(54) Composition for deterring animals from chewing on wood

(76) Inventor: Phillip G. Landers, Sanford, FL (US)

Correspondence Address: William M. Hobby, III, 157 E. New England Avenue, #375, Winter Park, FL, 32789, US

(21) Appl. No.: 11/061,970

(22) Filed: Feb. 17, 2005

Related U.S. Application Data
(63) Continuation-in-part of application No. 10/364,184, filed on Feb. 11, 2003, now Pat. No. 6,697,694.

(51) Int. Cl. A01N 25/26; A01N 25/28; A01N 35/00

(52) U.S. Cl. 424/405; 424/417; 514/690

(57) ABSTRACT

A composition of material for coating the surface of a structure to prevent animals from chewing on the structure. The composition includes isophorone, organo-clay absorber, bisphenol A diglycidal ether polymer and a polyamide resin hardener. It may also have glass or mica flakes therein as well as a microencapsulated acrylic resin-based sealant and a flocculated silica thickener. The composition is painted or troweled onto a structure to deter animals from chewing on the structure. The composition can also be applied as a tape when coated on an adhesive backed flexible strip of plastic material or sandwiched between flexible strips of materials, one f which has an adhesive coated surface.

### BACKGROUND OF THE INVENTION

This patent application is a continuation-in-part application of my pending U.S. patent application Ser. No. 10/364,184, filed Feb. 11, 2003 for a Method & Composition for Deterring Animals from Chewing on Wood.

Wood, often treated with toxic wood preserving chemicals, is used in the construction of fences, stalls, corrals, and other structures to contain and house domestic and exotic animals and birds. These toxic chemical preservatives include, but are not limited to, creosote, pentachlorophenol, and arsenic salts, such as copper chromated arsenic. Chewing on and ingestion of both treated and untreated wood is known to cause severe medical problems and even the death of these animals. In addition, wood chewing can compromise the structural integrity and aesthetic appeal of the wood. Examples of such chewing can be found in domestic animals, such as dogs that chew on woodwork and furniture and horses that chew and “crib” on wooden fences, stalls, posts, and other wood structures used to house and contain them. Wood chewing by more exotic zoo animals is also prevalent.

While possibly not the worst of the wood chewing animals, horses, because of their numbers, inflict significant economic damage as a result of cribbing and wood chewing. It is thought that when a horse cribs on wood, his body releases endorphins, natural “drugs” which stimulate the pleasure center of his brain, so that he receives a “reward” (“pleasure drug”) every time he cribs. Often cribbers would rather crib than eat. Wood chewing horses can suffer colic from eating wood splinters.

This invention describes a compound that can be painted on wood structures to deter animals from chewing and cribbing.

Isophorone (3,5,5-trimethyl-2-cyclohen-one-1) compounds have been shown effective in deterring woodpeckers when painted on wood. Isophorone compounds have been shown in my U.S. Pat. No. 6,237,305 to be highly effective in penetrating and sealing wood. While effective on woodpeckers, field tests have shown that these formulations, while effective for woodpecker deterrence, do not provide long-term protection against wood chewing by larger animals, such as horses. The present invention describes a chewing deterring coating that encapsulates and time-releases an odor that most animals find offensive. This invention is an improvement over my previously patented isophorone deterrent technology as it identifies the sense being affected and extends the effectiveness from woodpeckers to other animals, such as horses and dogs.

The invention involves the use of isophorone, absorbed in a highly absorbent organo-clay, barriered by glass flake or mica, and encased in a chemically-resistant epoxy or other polymer matrix. The highly absorbent organo-clay is used to trap the isophorone. The glass flake or mica controls the dissipation of the volatile solvent by forming a mechanical structure of overlapping glass platelets. The chemical resistant polymer matrix binds and adheres the composition to the surface. Capsules of micro-encapsulated isophorone sealant, described in my patent application “Method of Deterring Woodpeckers”, may also be incorporated to reinforce the deterrence to increase the odorant level in the coating. While the deterring odor is constantly being released, the odor gets worse when the coating surface is breached. This reinforces the “behavior” training and preventing the animal from further chewing.

The above described coating is applied to exposed wood or other surfaces as a chewing deterrent to animals, such as horses, dogs, cats, squirrels, and other larger animals.

### SUMMARY OF THE INVENTION

A composition of material for coating the surface of a structure to prevent animals from chewing on the structure. The composition includes Isophorone, organo-clay absorber, bisphenol A diglycidal ether polymer and a polyamide resin hardener. It may also have glass flakes or mica therein as well as a microencapsulated acrylic resin-based sealant and a flocculated silica thickener. The composition is painted or troweled onto a structure to prevent animals from chewing on the structure. The composition can also be applied as a tape when coated onto an adhesive backed flexible strip of plastic material or when sandwiched between flexible strips of materials, one of which has an adhesive coated surface.

### DESCRIPTION OF THE PREFERRED EMBODIMENT

The present invention describes a method of deterring animals, and especially larger animals, such as horses, from chewing on structures and utilizing a coating that generates a deterrent smell when released by the animal chewing thereon. Isophorone is absorbed in a highly absorbent organo-clay, mixed with glass flake or mica, and blended into a chemically resistant structural polymer matrix and may have glass or mica flakes added therein. It will be clear that other methods of entrapping the Isophorone may also be utilized. When applied as a paint, a layer of overlapping glass or mica platelets in the composition controls dissipation of the isophorone that is absorbed in an organo clay to form a chemically resistant structural matrix. Concentration of the isophorone sealant compound can be increased by the addition of isophorone encapsulated pellets. Different sized pellets can be used to enhance the results.

A preferred resin composition by weight includes 8-15% glass or mica flakes; 5-10% organo-clay absorber; 40-50% isophorone (3,5,5-trimethyl-2-cyclohexen-one-1); 25-35% bisphenol A diglycidal ether polymer; 1-2% of a flocculated silica thickener; 1-2% of various color pigments; and optionally 8-20% micro-encapsulated acrylic resin-based sealant (optional). The glass or mica flakes are optional and other materials can be used in their place. The preferred hardener composition is 10-20% polyamide resin.

### EXAMPLE

A specific formula includes by weight 9% glass flake or mica; 6% organo-clay absorber; 37% isophorone (3,5,5-trimethyl-2-cyclohexen-one-1); 26% bisphenol A diglycidal ether polymer; 1% of a flocculated silica thickener; and 1% of various color pigments. A preferred hardener composition is 20% polyamide resin.

Another preferred formula includes by weight 30 to 40% isophorone, 40-50% organo-clay absorber, 25-35% bisphenol A diglycidal ether polymer combined with 10-20% polyamide resin hardener.

The preferred volatile liquid is isophorone (3,5,5-trimethyl-2-cyclohexen-one-1) obtained from Union Carbide. The glass flake, if used, is 1/32′ glass flake obtained from Glass Flake International but mica or other materials can also be used. The clay thickener is Claytone APA from Southern Clay Products and the flocculated silica thickener is Degusa Aerosil 200. The polymer resin is bisphenol A diglycidal ether obtained from Shell Chemical under their formulation Epon 828. The polyamide resin is obtained from Cognis Corporation under their formula Versamid 140. A polyvinyl chloride or PVC polymer resin or a PVC copolymer resin can be utilized in place of the epoxy resin. This can be done by substituting about various amounts of a PVC resin in place of the epoxy resin, such as 15% by weight.

The composition as set forth in the example can be applied to a wooden fence top rail or the top rail of a corral, for instance holding horses, which are well known to chew on rails of an enclosure. The composition is applied by painting, flow coating, or troweling the top of the wood railings which is the portion primarily chewed on by the horses. However, other sections can be coated as needed. A coating has the advantage of laying out the glass or mica flakes in a flat horizonal layer since a coating does not leave room for the glass to remain edgewise. The isophorone odor is slowly released at levels that are barely perceptible by humans (approximate 0.2 ppm) but are well within the range perceptible by various animals, such as horses and dogs. An animal chewing through the material and the glass will pass through the layer of overlapping glass platelets or other material that traps the isophorone released. The isophorone can be encapsulated into different size pellets as desired which pellets are broken upon an animal biting into the coating.

The method includes the mixing of an isophorone formula in accordance with the above example, applying the coating to a chewing surface, such as a wooden rail or the like, and then painting or troweling the coating on in a thin coat evenly and allowing the coating to cure. The coating can be applied to posts around stalls, especially in feeding areas; onto live trees or onto a paper or foam wrapping around a live tree; to fence rails, starting with the top rail and then to the lower rails; and to telephone poles.

The method also includes applying a coating of the composition to a strip of flexible plastic material having an adhesive coating on one side thereof, then curing the coating and applying the tape to a chewing surface. The coating composition can also be sandwiched between a pair of flexible plastic strips, such as polyethylene strips in which one strip has an adhesive coating thereon.

However, the present invention should not be construed as limited to the forms disclosed which should be considered illustrative rather than restrictive.

1. A composition for coating a structure surface to prevent animals from chewing on the structure comprising by weight: 30 to 40 percent isophorone, 40-50 percent organo-clay absorber, 25-35 percent bisphenol A diglycidal ether polymer combined with 10-20 percent polyamide resin hardener.

2. The composition for coating a structure surface to prevent animals from chewing on the structure in accordance with claim 1 having 8-15 percent by weight of Glass flakes therein.

3. The composition for coating a structure surface to prevent animals from chewing on the structure in accordance with claim 2 having 8-20 percent by weight of micro-encapsulated acrylic resin-based sealant therein.

4. The composition for coating a structure surface to prevent animals from chewing on the structure in accordance with claim 1 having 1-2 percent by weight of flocculated silica thickener therein.

5. A method of preventing animals from chewing on a surface including the steps of:
preparing a composition comprising isophorone, and a polymer resin;
coating the surface of an adhesive coated flexible plastic strip with said coating composition; and
adhesively attaching said coated plastic strip to the surface of a structure to prevent animals from chewing on the structure.

6. The method of preventing animals from chewing on a surface in accordance with claim 5 including the step of attaching a flexible plastic strip over said coating composition on said coated plastic strip to sandwich said composition between two flexible plastic strips.
